(19) United States
(12) Patent Application Publication
(10) Pub. No.: US 2016/0285258 A1
(43) Pub. Date: Sep. 29, 2016

(54) SAFETY CLAMP SYSTEM FOR EMERGENCY START OF VEHICLE BATTERY

(71) Applicants: Kun-Chang WU, Tainan City (TW); CHAMPARTS ELECTRONIC TECHNOLOGY CO., LTD., Shenzhen (CN)

(72) Inventors: Kun-Chang WU, Tainan City (TW); Po-Hung CHEN, New Taipei City (TW); Page XING, Qixian (CN)

(21) Appl. No.: 14/861,540

(22) Filed: Sep. 22, 2015

Related U.S. Application Data
(60) Provisional application No. 62/137,453, filed on Mar. 24, 2015.

(51) Int. Cl. H02H 9/04

(52) U.S. Cl. CPC H02H 9/041

(57) ABSTRACT

A safety clamp system for an emergency start of a vehicle battery comprises a boost circuit, a voltage-stabilizing circuit, a control unit, a power detection circuit, a battery-clamp-loose detection circuit, an alarm circuit, an auto-detect-battery-voltage-and-short-circuit detection circuit, a driving circuit and a turn-on/off detection circuit. The power detection circuit and the auto-detect-battery-voltage-and-short-circuit detection circuit detect whether an input voltage or the vehicle battery is normal or abnormal. If normal, the control unit controls the driving circuit to drive the turn-on/off detection circuit, so that a power supplied by an external lithium battery is sent to the vehicle battery. If abnormal, abnormal detection signals are sent to the control unit to drive the alarm circuit. If a battery clamp is loose, the control unit controls the driving circuit to stop driving the turn-on/off detection circuit, so that the power is not sent to the vehicle battery.

### CROSS-REFERENCE TO RELATED APPLICATION

This patent application claims the benefit of U.S. Provisional Patent Application No. 62/137,453 filed Mar. 24, 2015, which is incorporated by reference herein.

### BACKGROUND OF THE INVENTION

1. Field of the Invention

The present invention relates to a protection apparatus (namely, a safety clamp system), and especially relates to a safety clamp system for an emergency start of a vehicle battery.

2. Description of the Related Art

The related art clamp apparatus for the vehicle battery is not safe. For example, when the related art clamp apparatus touches the vehicle battery, the electric spark is generated. When two clamps of the related art clamp apparatus touch each other, the positive electrode and the negative electrode of the vehicle battery are short-circuit, so that the vehicle battery may explode to hurt people. When the vehicle is started, if the clamp is loose due to vehicle vibration, the clamp may touch the metal of the vehicle to result in safety problem.

### SUMMARY OF THE INVENTION

The main object of the present invention is to design the safety clamp system with the concept of intelligence and safety. When the clamps clamp the vehicle battery, the protective plate automatically detects the electric quantity of the vehicle battery. The electronic switch is turned on to provide the vehicle battery with enough energy (voltage/current) to start the vehicle. Moreover, the present invention has the function that can automatically detect whether the electric spark is generated or not, and starts the vehicle when there is no electric spark. The present invention also has the protection function for the loose clamp, and the protection function for incorrect reverse connection.

In order to achieve the object of the present invention mentioned above, the present invention provides a safety clamp system for an emergency start of a vehicle battery. The safety clamp system is electrically connected between an external lithium battery and the vehicle battery. The safety clamp system comprises a boost circuit, a voltage-stabilizing (namely, voltage regulator) circuit, a control unit, a power detection circuit, a battery-clamp-loose detection circuit, an alarm circuit, an auto-detect-battery-voltage-and-short-circuit detection circuit, a driving circuit and a turn-on/off detection circuit.

The power detection circuit and the auto-detect-battery-voltage-and-short-circuit detection circuit detect an input voltage and the vehicle battery, and then abnormal detection signals are sent to the control unit. The control unit controls the driving circuit to drive the turn-on/off detection circuit and the alarm circuit for supplying power and protection.

In another word, the power detection circuit detects an input voltage sent from the external lithium battery. If the input voltage is abnormal (for example, the input voltage is lower than a standard voltage, such as 10.8V), the power detection circuit generates a power abnormal signal and then the power detection circuit sends the power abnormal signal to the control unit. The auto-detect-battery-voltage-and-short-circuit detection circuit detects the vehicle battery (or, an external power output positive side and an external power output negative side of the safety clamp system). If the vehicle battery (or, the external power output positive side and the external power output negative side) is abnormal (for example, the external power output positive side and the external power output negative side are short-circuit or receive a heavy current), the auto-detect-battery-voltage-and-short-circuit detection circuit generates a battery abnormal signal and then the auto-detect-battery-voltage-and-short-circuit detection circuit sends the battery abnormal signal to the control unit. The control unit controls the driving circuit to drive (namely, turn on) the turn-on/off detection circuit, so that the external lithium battery supplies power (namely, the input voltage) to the vehicle battery. If the control unit receives the power abnormal signal or the battery abnormal signal, the control unit controls the driving circuit to stop driving (namely, turn off) the turn-on/off detection circuit, so that the external lithium battery does not supply power (namely, the input voltage) to the vehicle battery, and then the control unit drives the alarm circuit for alarm and protection.

Moreover, the battery-clamp-loose detection circuit detects that a battery clamp is loose. No voltage is sent to the control unit, so that the control unit outputs no signal.

In another word, the battery-clamp-loose detection circuit detects whether a battery clamp which is connected to the battery-clamp-loose detection circuit is connected to the vehicle battery or not. If the battery clamp is not connected to the vehicle battery, the battery-clamp-loose detection circuit informs the control unit that the battery clamp is not connected to the vehicle battery, and then the control unit controls the driving circuit to stop driving (namely, stop turning on) the turn-on/off detection circuit, so that power supplied by the external lithium battery is not sent to the vehicle battery. In an embodiment, the battery-clamp-loose detection circuit detects whether the battery clamp originally clamping the vehicle battery is loose from the vehicle battery (namely, the battery clamp is not connected to the vehicle battery anymore) or not, and then informs the control unit. If the battery clamp originally clamping the vehicle battery is loose from the vehicle battery, the battery-clamp-loose detection circuit informs the control unit that the battery clamp originally clamping the vehicle battery is loose from the vehicle battery, and then the control unit controls the driving circuit to stop driving (namely, stop turning on) the turn-on/off detection circuit, so that the power (namely, the input voltage) supplied by the external lithium battery is not sent to the vehicle battery.

In an embodiment of the present invention, the boost circuit comprises (or is consist of) a first resistor, a second resistor, a third resistor, a fourth resistor, a voltage-stabilizing diode, a diode, a first capacitor, a second capacitor, a first inductor, a second inductor and a boost chip which are electrically connected to each other. The boost circuit boosts an external lithium battery voltage which is outputted from the external lithium battery, so that the external lithium battery voltage becomes a predetermined voltage, and then the boost circuit outputs the predetermined voltage.

In an embodiment of the present invention, the voltage-stabilizing circuit comprises (or is consist of) a fifth resistor, a third capacitor, a fourth capacitor, a fifth capacitor and a voltage-stabilizing chip which are electrically connected to each other. The voltage-stabilizing circuit regulates and stabilizes the predetermined voltage outputted from the boost circuit as a stabilized (namely, constant) voltage.

In an embodiment of the present invention, the control unit comprises a control chip.

In an embodiment of the present invention, the power detection circuit comprises (or is consist of) a sixth resistor, a thirteenth resistor and a ninth capacitor which are electrically connected to each other.

In an embodiment of the present invention, the battery-clamp-loose detection circuit comprises (or is consist of) an eighteenth resistor, a nineteenth resistor and a tenth capacitor which are electrically connected to each other.

In an embodiment of the present invention, the auto-detect-battery-voltage-and-short-circuit detection circuit comprises (or is consist of) an eleventh resistor, a sixteenth resistor and a seventh capacitor which are electrically connected to each other.

In an embodiment of the present invention, the driving circuit comprises (or is consist of) a seventh resistor, an eighth resistor, a ninth resistor, a fourteenth resistor, a seventeenth resistor, an eighth capacitor, a first transistor and a second transistor which are electrically connected to each other.

In an embodiment of the present invention, the turn-on/off detection circuit comprises (or is consist of) a tenth resistor, a fifteenth resistor, a first field effect transistor, a second field effect transistor, a third field effect transistor and a fourth field effect transistor which are electrically connected to each other.

In an embodiment of the present invention, the alarm circuit comprises (or is consist of) a twelfth resistor, a first light emitting diode and a second light emitting diode which are electrically connected to each other.

In an embodiment of the present invention, the safety clamp system further comprises an external power input positive side, an external power input negative side, an external power output positive side, an external power output negative side and a clamp potential detection side electrically connected to the external lithium battery and the vehicle battery respectively.

### BRIEF DESCRIPTION OF DRAWING

FIG. 1 shows a block diagram of the safety clamp system of the present invention.

FIG. 2 shows a circuit diagram of the safety clamp system of the present invention.

### DETAILED DESCRIPTION OF THE INVENTION

Please refer to following detailed description and figures for the technical content of the present invention.

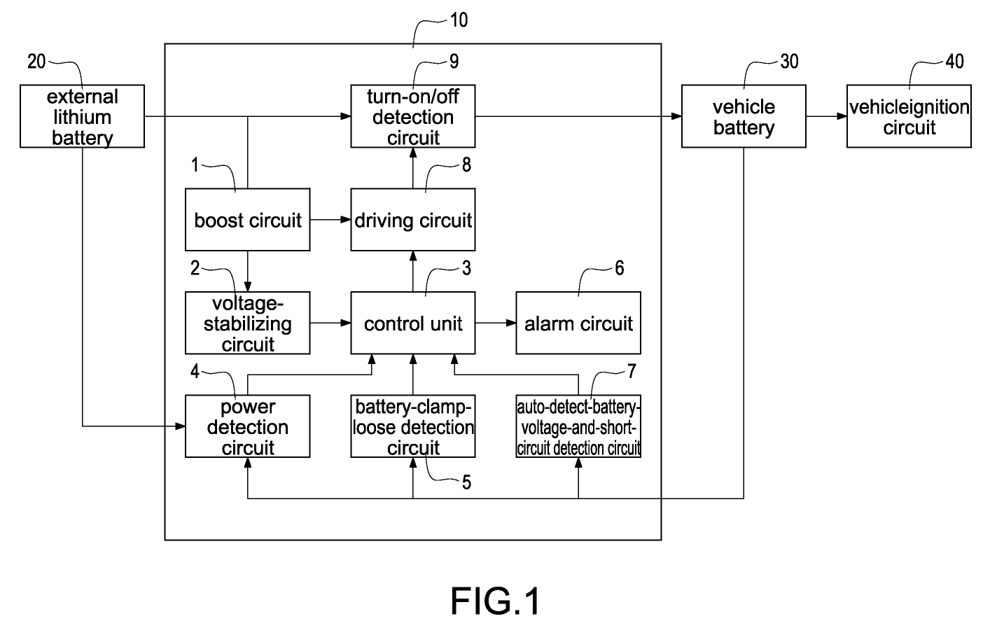

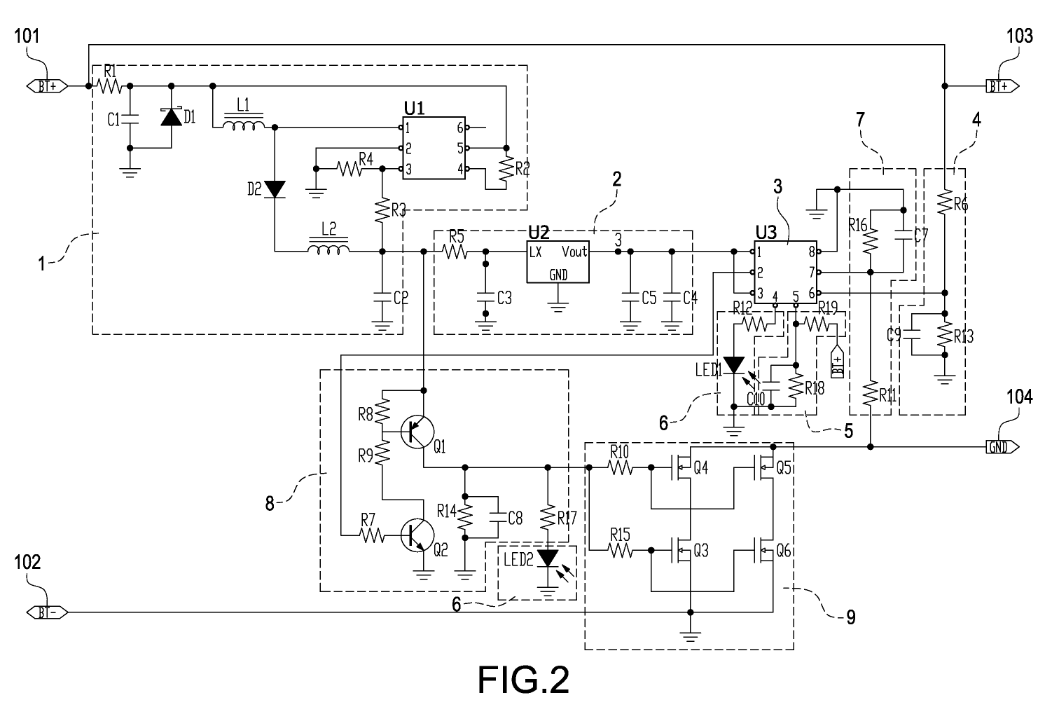

FIG. 1 shows a block diagram of the safety clamp system of the present invention. FIG. 2 shows a circuit diagram of the safety clamp system of the present invention. As shown in FIG. 1 and FIG. 2, a safety clamp system 10 for an emergency start of a vehicle battery 30 comprises a boost circuit 1, a voltage-stabilizing (namely, voltage regulator) circuit 2, a control unit 3, a power detection circuit 4, a battery-clamp-loose detection circuit 5, an alarm circuit 6, an auto-detect-battery-voltage-and-short-circuit detection circuit 7, a driving circuit 8 and a turn-on/off detection circuit 9 which are electrically connected to an external lithium battery 20 (12V/200-800 A) and the vehicle battery 30 respectively (as shown in FIG. 1). The vehicle battery 30 is electrically connected to a vehicle ignition circuit 40.

The safety clamp system 10 of the present invention detects the external electrical parameters and sends the values which are generated by the electrical parameters to the control chip U3 of the control unit 3 for calculating. Finally, the calculated result is outputted to the driving circuit 8 to drive the turn-on/off detection circuit 9 (12V/200-800 A) to turn on or turn off the conduction between the external lithium battery 20 (12V/200-800 A) and the vehicle battery 30. At the same time, the statuses which are required to alert the user are indicated by the alarm circuit 6.

Please refer to FIG. 2. As shown in FIG. 2, the safety clamp system 10 further comprises an external power input positive side (BT+) 101, an external power input negative side (BT−) 102, an external power output positive side (BT+) 103, an external power output negative side (GND) 104 and an clamp potential detection side (BT+) 105. The safety clamp system 10 comprises a control chip U3. The first pin of the control chip U3 is connected to the third pin (the voltage output side Vout) of the voltage-stabilizing chip U2 of the voltage-stabilizing circuit 2. The first pin of the control chip U3 is connected to ground through the fourth capacitor C4 and the fifth capacitor C5. The second pin of the control chip U3 is connected to the base of the second transistor Q2 of the driving circuit 8 through the seventh resistor R7. The third pin of the control chip U3 is connected to the first pin of the control chip U3 in parallel. The fourth pin of the control chip U3 is connected to the anode of the first light emitting diode LED1 of the alarm circuit 6. The cathode of the first light emitting diode LED1 is connected to ground. The fifth pin of the control chip U3 is connected to ground through the circuit comprising the tenth capacitor C10 and the eighteenth resistor R18 of the battery-clamp-loose detection circuit 5 connected to each other in parallel. The fifth pin of the control chip U3 is connected to the clamp potential detection side 105 through the nineteenth resistor R19 of the battery-clamp-loose detection circuit 5. The sixth pin of the control chip U3 is connected to the external power input positive side 101 and the external power output positive side 103 through the sixth resistor R6 of the power detection circuit 4, and is connected to ground through the circuit comprising the ninth capacitor C9 and the thirteenth resistor R13 of the power detection circuit 4 connected to each other in parallel. The seventh pin of the control chip U3 is connected to ground through the circuit comprising the seventh capacitor C7 and the sixteenth resistor R16 of the auto-detect-battery-voltage-and-short-circuit detection circuit 7 connected to each other in parallel, and is connected to the external power output negative side 104 through the eleventh resistor R11 of the auto-detect-battery-voltage-and-short-circuit detection circuit 7. The eighth pin of the control chip U3 is connected to ground.

The voltage-stabilizing circuit 2 comprises a voltage-stabilizing chip U2. The first pin of the voltage-stabilizing chip U2 is connected to ground through the third capacitor C3, and is connected to one side of the second inductor L2 through the fifth resistor R5. The second pin of the voltage-stabilizing chip U2 is connected to ground. The third pin of the voltage-stabilizing chip U2 is connected to the first pin of the control chip U3.

The boost circuit 1 comprises a boost chip U1. The first pin of the boost chip U1 is connected to one side of the first inductor L1 and the anode of the diode D2. The second pin of the boost chip U1 is connected to ground. The third pin of the boost chip U1 is connected to ground through the fourth resistor R4, and is connected to one side of the second capacitor C2 and one side of the second inductor L2 through the third resistor R3. The other side of the second capacitor C2 is connected to ground. The other side of the second inductor L2 is connected to the cathode of the diode D2. The fourth pin of the boost chip U1 is connected to the other side of the first inductor L1 through the second resistor R2. The fifth pin of the boost chip U1 is connected to the cathode of the voltage-stabilizing diode D1. The cathode of the voltage-stabilizing diode D1 is connected to the external power input positive side 101 and the external power output positive side 103 through the first resistor R1. The anode of the voltage-stabilizing diode D1 is connected to ground.

The base of the first transistor Q1 of the driving circuit 8 is connected to one side of the eighth resistor R8 and one side of the ninth resistor R9. The emitter of the first transistor Q1 is connected to the other side of the eighth resistor R8 and one side of the fifth resistor R5. The collector of the first transistor Q1 is connected to one side of the fourteenth resistor R14, one side of the seventeenth resistor R17, one side of the tenth resistor R10 and one side of the fifteenth resistor R15. The other side of the fourteenth resistor R14 is connected to ground. The fourteenth resistor R14 is connected to the eighth capacitor C8 in parallel. The other side of the seventeenth resistor R17 is connected to the anode of the first light emitting diode LED1. The cathode of the first light emitting diode LED1 is connected to ground.

The base of the second transistor Q2 of the driving circuit 8 is connected to one side of the seventh resistor R7. The emitter of the second transistor Q2 is connected to ground. The collector of the second transistor Q2 is connected to the base of the first transistor Q1 through the ninth resistor R9.

The gate of the first field effect transistor Q3 of the turn-on/off detection circuit 9 is connected to the other side of the fifteenth resistor R15 and the gate of the fourth field effect transistor Q6. The drain of the first field effect transistor Q3 is connected to the drain of the second field effect transistor Q4. The source of the first field effect transistor Q3 is connected to ground, the external power input negative side 102 and the source of the fourth field effect transistor Q6.

The gate of the second field effect transistor Q4 of the turn-on/off detection circuit 9 is connected to the other side of the tenth resistor R10 and the gate of the third field effect transistor Q5. The drain of the first field effect transistor Q3 is connected to the drain of the second field effect transistor Q4. The source of the second field effect transistor Q4 is connected to the source of the third field effect transistor Q5, one side of the eleventh resistor R11 and the external power output negative side 104.

The gate of the third field effect transistor Q5 of the turn-on/off detection circuit 9 is connected to the gate of the second field effect transistor Q4. The drain of the third field effect transistor Q5 is connected to the drain of the fourth field effect transistor Q6. The source of the third field effect transistor Q5 is connected to the source of the second field effect transistor Q4, one side of the eleventh resistor R11 and the external power output negative side 104.

The gate of the fourth field effect transistor Q6 of the turn-on/off detection circuit 9 is connected to the gate of the first field effect transistor Q3. The drain of the fourth field effect transistor Q6 is connected to the drain of the third field effect transistor Q5. The source of the fourth field effect transistor Q6 is connected to ground.

The operating principles of the safety clamp system 10 of the present invention are described as following:

The external power input positive side 101 and the external power input negative side 102 are connected to the external lithium battery 20. The external power output positive side 103 and the external power output negative side 104 are connected to the vehicle battery 30.

The power received by the external power input positive side 101 is current-limited by the first resistor R1, filtered by the first capacitor C1 and voltage-stabilized by the voltage-stabilizing diode D1 to supply power to the fifth pin of the boost chip U1. The fifth pin of the boost chip U1 provides the fourth pin of the boost chip U1 with a trigger voltage through the second resistor R2. The boost chip U1 works to output power to the circuit (the boost circuit 1) comprising the first inductor L1, the diode D2, the second inductor L2, the third resistor R3 and the fourth resistor R4 to boost the input power +12V to a predetermined voltage +15V. The predetermined voltage +15V is filtered by the second capacitor C2, current-limited by the fifth resistor R5 and filtered by the third capacitor C3, and then sent to the input side of the voltage-stabilizing chip U2. The voltage-stabilizing chip U2 stabilizes (namely, regulates) the predetermined voltage +15V to become a stabilized voltage about +5V to send to the fifth capacitor C5 and the fourth capacitor C4 for filtering, then to send to the first pin and the third pin of the control chip U3.

When the vehicle battery 30 connected to the external power output positive side 103 and the external power output negative side 104 is lack of power, the external power output negative side 104 sends a trigger voltage to the seventh pin of the control chip U3 through the eleventh resistor R11 and the sixteenth resistor R16 (of the auto-detect-battery-voltage-and-short-circuit detection circuit 7) for voltage dividing. The second pin of the control chip U3 outputs +5V voltage to the base of the second transistor Q2 through the seventh resistor R7 of the driving circuit 8, so that the second transistor Q2 is turned on, and then the voltage of the base of the first transistor Q1 is pulled low, so that the first transistor Q1 is turned on as well. The +15V voltage is sent to the seventeenth resistor R17 through the first transistor Q1. When the 15V voltage is flowing through the seventeenth resistor R17 and the second light emitting diode LED2 to the external power input negative side 102, the second light emitting diode LED2 of the alarm circuit 6 lights. The output of the driving circuit 8 is sent to the gates of the first field effect transistor Q3 and the fourth field effect transistor Q6 through the fifteenth resistor R15 of the turn-on/off detection circuit 9 to drive the first field effect transistor Q3 and the fourth field effect transistor Q6. The output of the driving circuit 8 is also sent to the gates of the second field effect transistor Q4 and the third field effect transistor Q5 through the tenth resistor R10 of the turn-on/off detection circuit 9 to drive the second field effect transistor Q4 and the third field effect transistor Q5. Therefore, the first field effect transistor Q3, the second field effect transistor Q4, the third field effect transistor Q5 and the fourth field effect transistor Q6 of the turn-on/off detection circuit 9 are turned on, and namely the turn-on/off detection circuit 9 is turned on. The voltage supplied by the external lithium battery 20 is flowing through the turn-on/off detection circuit 9, so that the external power output positive side 103 and the external power output negative side 104 output +12V voltage.

When the input voltage of the external power input positive side 101 and the external power input negative side 102 is lower than 10.8V, the input voltage of the external power input positive side 101 and the external power input negative side 102 is voltage-divided by the sixth resistor R6 and the thirteenth resistor R13 of the power detection circuit 4, and then sent to the sixth pin of the control chip U3 of the control unit 3. The second pin of the control chip U3 does not output 5V, so that the first field effect transistor Q3, the second field effect transistor Q4, the third field effect transistor Q5 and the fourth field effect transistor Q6 are not driven, and the turn-on/off detection circuit 9 is turned off. The external power output positive side 103 and the external power output negative side 104 do not output 12V. The fourth pin of the control chip U3 outputs 5V to the first light emitting diode LED1 (red) through the twelfth resistor R12 of the alarm circuit 6. The first light emitting diode LED1 is lighting for alarming that the input voltage of the external power input positive side 101 and the external power input negative side 102 is low (namely, low voltage protection).

When the external power output positive side 103 and the clamp potential detection side 105 are short-circuit through the teeth of two sides of the clamp, and when the red clamp (usually connected to the positive pole) is removed (or separated) from the vehicle battery 30, the clamp potential detection side 105 is cut off instantly, and the divided-voltage of the fifth pin of the control chip U3 through the clamp potential detection side 105, the nineteenth resistor R19 and the eighteenth resistor R18 is 0V. The second pin of the control chip U3 outputs nothing. The external power input negative side 102 is cut off from the external power output negative side 104 (namely, the external power input negative side 102 is not conducted to the external power output negative side 104).

When the external power output positive side 103 and the external power output negative side 104 are short-circuit, the seventh pin of the control chip U3 receives a signal which is generated from the divided-voltage by the eleventh resistor R11 and the sixteenth resistor R16 of the auto-detect-battery-voltage-and-short-circuit detection circuit 7 through the external power output positive side 103 and the external power output negative side 104. At this time, the second pin of the control chip U3 outputs no signal. The first field effect transistor Q3, the second field effect transistor Q4, the third field effect transistor Q5 and the fourth field effect transistor Q6 of the turn-on/off detection circuit 9 are turned off. The external power output positive side 103 and the external power output negative side 104 output no voltage. The fourth pin of the control chip U3 outputs an on-off signal to the first light emitting diode LED1 through the twelfth resistor R12 of the alarm circuit 6. The first light emitting diode LED1 is blinking for alarming this problem (namely, short-circuit protection and alarm is achieved).

After starting normally, if the external power output positive side 103 and the external power output negative side 104 receive a heavy current, the control chip U3 receives a signal which is generated from the divided-voltage by the sixth resistor R6 and the thirteenth resistor R13 of the power detection circuit 4 through the external power output positive side 103. Inside the control chip U3, the control chip U3 counts time for 3 seconds. After 3 seconds, the second pin of the control chip U3 outputs a signal (or outputs no signal) to turn off the driving circuit 8, so that the driving circuit 8 cannot drive (namely, turn on) the turn-on/off detection circuit 9, to achieve over-current protection.

After the vehicle battery 30 connected to the external power output positive side 103 and the external power output negative side 104 starts in an emergency, the vehicle engine will charge (or back-charge) the vehicle battery 30, so that the safety clamp system 10 is charged (or back-charged) through the clamps. The sixth pin of the control chip U3 receives a signal which is generated from the divided-voltage by the sixth resistor R6 and the thirteenth resistor R13 of the power detection circuit 4 through the external power output positive side 103 receiving the back-charging voltage. Then, the second pin of the control chip U3 stops outputting signals, so that the driving circuit 8 is turned off, so that the driving circuit 8 cannot drive (namely, turn on) the turn-on/off detection circuit 9, to achieve anti-back-charged protection.

When the external power output positive side 103 and the external power output negative side 104 are connected to the vehicle battery 30, the safety clamp system 10 will detect the voltage of the vehicle battery 30 automatically. The seventh pin of the control chip U3 receives a signal which is generated from the divided-voltage by the eleventh resistor R11 and the sixteenth resistor R16 of the auto-detect-battery-voltage-and-short-circuit detection circuit 7 through the external power output negative side 104. The second pin of the control chip U3 output signals, so that the first field effect transistor Q3, the second field effect transistor Q4, the third field effect transistor Q5 and the fourth field effect transistor Q6 of the turn-on/off detection circuit 9 are turned on. At this time, the second light emitting diode LED2 of the alarm circuit 6 is lighting in green, to achieve auto-detecting-starting function.

When the external power output positive side 103 and the external power output negative side 104 are connected to the positive pole and the negative pole of the vehicle battery 30, if the voltage of the vehicle battery 30 is higher than the voltage of the external power output positive side 103 and the external power output negative side 104, the seventh pin of the control chip U3 receives a signal which is generated from the divided-voltage by the sixth resistor R6 and the thirteenth resistor R13 of the power detection circuit 4 through the external power output positive side 103, so that the second pin of the control chip U3 outputs no signal, so that the driving circuit 8 is turned off, and the driving circuit 8 cannot drive (namely, turn on) the turn-on/off detection circuit 9. The first field effect transistor Q3, the second field effect transistor Q4, the third field effect transistor Q5 and the fourth field effect transistor Q6 are turned off to achieve voltage-controlling-detecting function for the vehicle battery 30.

The description and figures of the embodiments of the safety clamp system 10 of the present invention shown above achieve the purpose that the vehicle battery 30 is connected to the external power safely. Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A safety clamp system for an emergency start of a vehicle battery, the safety clamp system electrically connected between an external lithium battery and the vehicle battery, the safety clamp system comprising:
a boost circuit electrically connected to the external lithium battery;
a voltage-stabilizing circuit electrically connected to the boost circuit;
a control unit electrically connected to the voltage-stabilizing circuit;
a power detection circuit electrically connected to the external lithium battery, the vehicle battery and the control unit;
a battery-clamp-loose detection circuit electrically connected to the vehicle battery and the control unit;
an auto-detect-battery-voltage-and-short-circuit detection circuit electrically connected to the vehicle battery and the control unit;
a driving circuit electrically connected to the boost circuit and the control unit;
a turn-on/off detection circuit electrically connected to the external lithium battery, the vehicle battery and the driving circuit; and
an alarm circuit electrically connected to the control unit,
wherein the power detection circuit and the auto-detect-battery-voltage-and-short-circuit detection circuit detect an input voltage and the vehicle battery, and then abnormal detection signals are sent to the control unit; the control unit controls the driving circuit to drive the turn-on/off detection circuit and the alarm circuit for supplying power and protection; the battery-clamp-loose detection circuit detects that a battery clamp is loose; no voltage is sent to the control unit, so that the control unit outputs no signal.

2. The safety clamp system in claim 1, wherein the boost circuit comprises a first resistor, a second resistor, a third resistor, a fourth resistor, a voltage-stabilizing diode, a diode, a first capacitor, a second capacitor, a first inductor, a second inductor and a boost chip electrically connected to each other; the boost circuit boosts an external lithium battery voltage outputted from the external lithium battery, so that the external lithium battery voltage becomes a predetermined voltage, and the boost circuit outputs the predetermined voltage.

3. The safety clamp system in claim 1, wherein the voltage-stabilizing circuit comprises a fifth resistor, a third capacitor, a fourth capacitor, a fifth capacitor and a voltage-stabilizing chip electrically connected to each other; the voltage-stabilizing circuit regulates and stabilizes a voltage outputted from the boost circuit as a stabilized voltage.

4. The safety clamp system in claim 1, wherein the control unit comprises a control chip.

5. The safety clamp system in claim 1, wherein the power detection circuit comprises a sixth resistor, a thirteenth resistor and a ninth capacitor electrically connected to each other.

6. The safety clamp system in claim 1, wherein the battery-clamp-loose detection circuit comprises an eighteenth resistor, a nineteenth resistor and a tenth capacitor electrically connected to each other.

7. The safety clamp system in claim 1, wherein the auto-detect-battery-voltage-and-short-circuit detection circuit comprises an eleventh resistor, a sixteenth resistor and a seventh capacitor electrically connected to each other.

8. The safety clamp system in claim 1, wherein the driving circuit comprises a seventh resistor, an eighth resistor, a ninth resistor, a fourteenth resistor, a seventeenth resistor, an eighth capacitor, a first transistor and a second transistor electrically connected to each other.

9. The safety clamp system in claim 1, wherein the turn-on/off detection circuit comprises a tenth resistor, a fifteenth resistor, a first field effect transistor, a second field effect transistor, a third field effect transistor and a fourth field effect transistor electrically connected to each other.

10. The safety clamp system in claim 1, wherein the alarm circuit comprises a twelfth resistor, a first light emitting diode and a second light emitting diode electrically connected to each other.

11. The safety clamp system in claim 1, further comprising an external power input positive side, an external power input negative side, an external power output positive side, an external power output negative side and a clamp potential detection side electrically connected to the external lithium battery and the vehicle battery respectively.
